(19) United States
(12) Patent Application Publication
(10) Pub. No.: US 2006/0131897 A1
(43) Pub. Date: Jun. 22, 2006

(54) Door latch mounting bracket

(75) Inventors: Paul Ha, Grand Junction, CO (US); Michael B. Weis, Centennial, CO (US)

Correspondence Address: HAHN LOESER & PARKS, LLP, One GOJO Plaza, Suite 300, AKRON, OH, 44311-1076, US

(73) Assignee: The Steelworks Corporation

(21) Appl. No.: 11/015,481

(22) Filed: Dec. 17, 2004

(51) Int. Cl. E05B 9/00

(52) U.S. Cl. 292/337

(57) ABSTRACT

A mounting plate used to attach a latch set to a door. The mounting plate includes two sets of attachment apertures (one set is used with a long plate and the other set is used with a rose) and a pair of retention apertures. The retention apertures have a keyhole or teardrop shape that accepts the head of a retention boss on a long plate. Rotation of the long plate relative to the mounting plate causes the retention boss head to engage the mounting plate and attaches the long plate to the mounting plate.

### BACKGROUND OF THE INVENTION

This invention relates generally to door latches and more particularly to a mounting bracket for use when installing door latches.

Door latches, including cylindrical passage sets, lock sets, mortise locks, and the like, generally comprise a housing disposed in an opening formed in the free, or unhinged, edge of a door. The housing accommodates the latch components including a latch bolt which projects from the housing beyond the edge of the door and into an opening in the door frame to latch the door in a closed position. The latch bolt is moveable by operation of a mechanism in the housing for retracting the latch bolt into the housing to permit opening of the door. A latch operator, such as a door knob or lever handle, is mounted to the door face and operably connected to the latch retraction mechanism through a transverse passage in the door for selective retraction of the latch bolt upon actuation of the latch operator.

Latch operators are typically mounted to the door and door latch by support structure including a long plate or rose assembly. The long plate assembly is secured on the door or to the door latch and is configured to allow operative connection between the latch operator and latch retraction mechanism. Mounting the latch operator involves the steps of positioning the latch operator and associated long plate assembly against the surface of the door and using fasteners to secure the latch operator to the housing in the door, or to the other long plate assembly and latch operator on the opposite side of the door. The long plate assembly is fixed against rotation while rotatably supporting operation of the latch operator.

Conventional latch operator installation involves the manipulation of several parts and takes considerable time. The installation apparatus can also require threaded components and other support structure to provide the necessary rotational stability to the assembly, all of which can add cost of manufacturing.

The foregoing illustrates limitations known to exist in present door latches. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In one aspect of the present invention, this is accomplished by providing a mounting plate comprising: a plate having a central aperture therein; a plurality of sets of attachment apertures in the plate, each set comprising two attachment apertures, the two attachment apertures in each set being diametrically opposed to one another about the central aperture; and two retention apertures in the plate, the two retention apertures being diametrically opposed to one another about the central aperture.

In another aspect of the present invention, this is accomplished by providing a latch set comprising: a mounting plate according to the present invention; a first latch operator having two female threaded bosses; a second latch operator having two retention bosses; and two screws, the screws extending through the attachment apertures of one set of attachment apertures and threadedly engaging the first latch operator female threaded bosses, each retention boss extending through a mounting plate retention aperture and retainingly engaging the mounting plate with the second latch operator.

In a further aspect of the present invention, this is accomplished by providing a latch set comprising: two latch operators; and a mounting plate attached to the latch operators, the mounting plate having a central aperture, two sets of attachment apertures, the two attachment apertures in a set being diametrically opposed to one another about the central aperture; and two retention apertures diametrically opposed to one another about the central aperture, the mounting plate being attached to one latch operator using one set of attachment apertures, the mounting plate being attached to the other latch operator using the retention apertures.

In another aspect of the present invention, this is accomplished by providing a method of installing a latch set on a door comprising the steps of:
providing a first latch operator, the first latch operator having two female threaded bosses;
providing a second latch operator, the second latch operator having two retention bosses extending therefrom;
providing a mounting plate, the mounting plate having: a central aperture; two attachment apertures diametrically opposed to one another about the central aperture; and two retention apertures diametrically opposed to one another about the central aperture;
positioning the first latch operator on a first side of the door, the two female threaded bosses extending into a bore in the door;
manually holding the first latch operator on the first side of the door;
positioning the mounting plate on a second side of the door, the mounting plate central aperture being aligned with the door bore;
attaching the mounting plate to the first latch operator with a plurality of screws;
releasing the manual holding of the first latch operator;
positioning the second latch operator on the second side of the door, and aligning the second latch operator in a position rotated from a normal installed position of the second latch operator;
aligning the retention bosses with the larger end of the mounting plate retention apertures;
placing the retention boss heads through the larger end of the mounting plate retention apertures; and
attaching the second latch operator to the mounting plate by rotating the second latch operator to the normal installed position.

The foregoing and other aspects will become apparent from the following detailed description of the invention when considered in conjunction with the accompanying drawing figures.

### BRIEF DESCRIPTION OF THE DRAWING FIGURES

FIG. 1 is an exploded perspective view showing a latch set, using long plates, and a mounting plate according to the present invention;

FIG. 1A is an exploded perspective view showing a latch set according to present invention, the latch set using a long plate and a rose;

FIG. 2 is a perspective view of the mounting plate shown in FIG. 1;

FIG. 3 is a perspective view of a retention boss for use with the mounting plate shown in FIG. 1;

FIG. 4 is a schematic plan view of a portion of the latch set shown in FIG. 1, illustrating the attachment of the mounting plate to one of the latch operators;

FIG. 5 is an exploded perspective view of a portion of the latch operator shown in FIG. 1, illustrating the attachment of the mounting plate to the other of the latch operators; and

FIG. 6 is a plan view illustrating the attachment of the other of the latch operators to the mounting plate.

### DETAILED DESCRIPTION

Shown in the FIGURES is a door latch or latch set 10 that includes a mounting bracket 50. Mounting bracket 50 can be used with a cylindrical lock set, such as is shown in the FIGURES, or can be used with other conventional door latches or door locks, such as mortise locks. Basically, latch set 10 comprises two latch operators 12, 14 and a latch 32. One latch operator is attached to one side of a door 16 and the other latch operator is attached to the other or second side of door 16. Each latch operator 12, 14 includes a spindle 24 that extends into a bore 17 in door 16 and engages the latch 32, so that when the lever (or knob) 22 is turned, the attached spindle causes latch 32 to retract and permits the door 16 to be opened. Depending on the details of the particular design, both latch operators 12, 14 have a spindle 24, or, one latch operator has a spindle 24, which extends through the latch 32 and engages the lever 22 on the other latch operator.

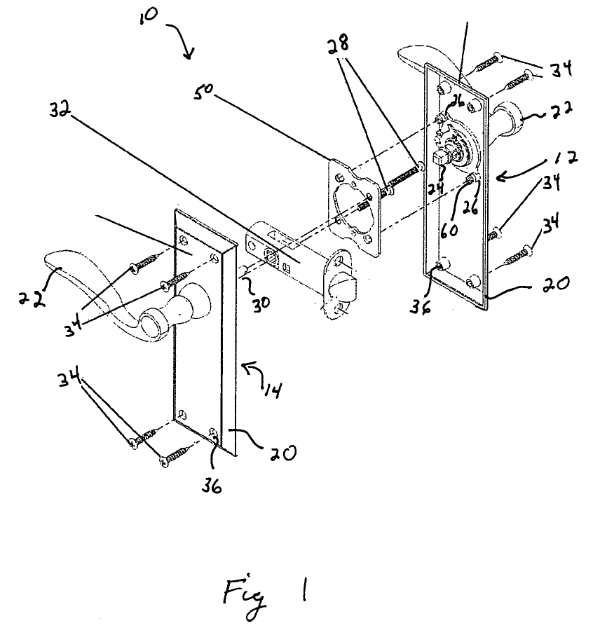

FIG. 1 shows latch operators 12, 14, where both latch operators comprise a “long plate” 20. As used in the industry, “long plate” means an extended plate, usually rectangular, attached to the door that supports the lever or knob and the latch operator including return springs, latch spindle, etc. The long plate may be a decorative escutcheon, as shown in the FIGURES, or a separate decorative escutcheon can be attached to the long plate. FIG. 1A shows a latch set 10 that uses a long plate 20 on one side of the door 16 and a “rose” 21 on the other side of the door. A “rose” is also a term of art in the industry and refers to a round support member. Sometimes the rose is oval or other shapes approximating a round or oval shape.

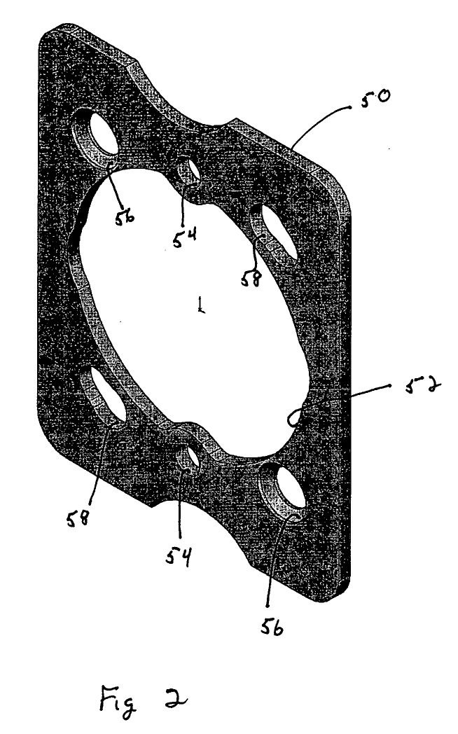

The long plate 20 has a plurality of tapered holes 36 that accept screws 34 for attaching the long plate 20 to the door 16. The inside surface of the long plate has a plurality of threaded bosses 26, typically diametrically positioned about a hole 37 in the long plate. Spindle 24 extends from lever 22 through hole 37. For use with the mounting plate 50, one long plate 20 (latch operator 12) has threaded retention bosses 60 (see FIG. 3) threaded into threaded bosses 26. The other long plate (latch operator 14) has extended threaded bosses 30 (only one is shown in the FIGURES) threaded into threaded bosses 26. Extended threaded bosses 30 have a male threaded section on the end that is attached to a long plate threaded boss 26, and have a female threaded section on the other end for accepting screws 28.

As shown in FIG. 3, retention boss 60 has a threaded shaft 62, a head 66 and a ramp or tapered section 64 between the head 66 and the threaded shaft 62. The diameter of the head 66 is larger than the diameter than the shaft 62. In a preferred embodiment, the tapered section 64 tapers from a first diameter near the head 66 to a smaller second diameter near the threaded shaft 62. The tapered section first diameter is less than the diameter of the head. Preferably, the tapered section second diameter is the same or greater than the diameter of the threaded shaft 62.

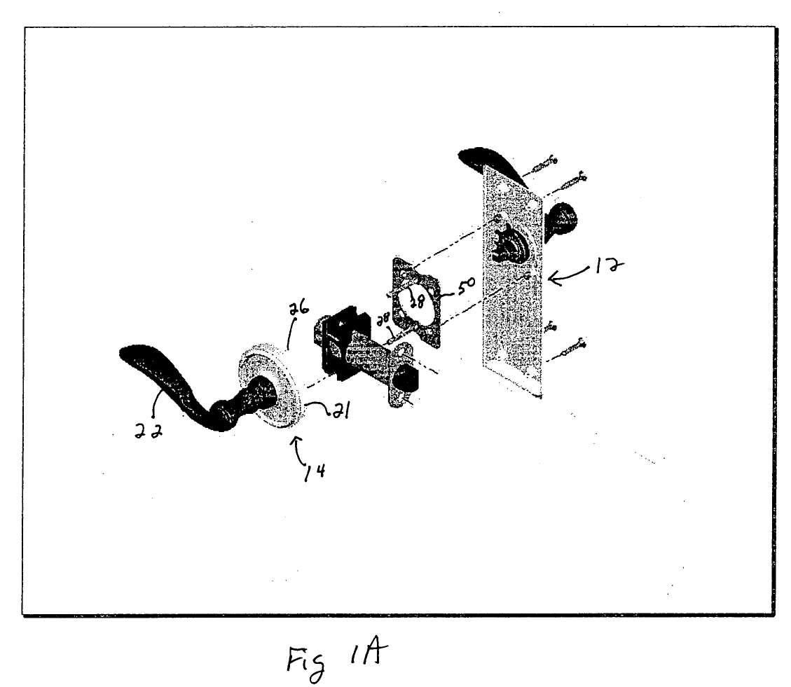

Referring to FIG. 2, mounting plate 50 has a central aperture 52 that permits passage of spindles 24 and other parts of latch operators 12, 14. Positioned about the central aperture 52 are three sets of diametrically opposed holes or apertures, 54, 56 and 58. Two sets, 54, 56, are attachment apertures, which with screws 28, are used to attach the mounting plate 50 to latch operator 14. Preferably, attachment apertures 54 are threaded and are used when mounting plate 50 is attached to a rose 21, see FIG. 1A. Apertures 56 are preferably unthreaded and are used when attaching mounting plate to a long plate 20. Retention apertures 58 have a larger portion and a smaller portion, such as a keyhole shape, a modified FIG. 8 shape or a teardrop shape. Retention apertures 58 cooperate with retention bosses 60 to attach latch operator 12 to mounting plate. Retention boss head 66 is smaller than the larger portion of the retention aperture 58, permitting head 66 to pass through retention aperture 58. When the long plate 12 is rotated relative to mounting plate 50, the retention boss tapered section 64 presses against the edges of the retention aperture 58, forcing mounting plate 50 towards long plate 12 until head 66 engages the surface of the mounting plate 50.

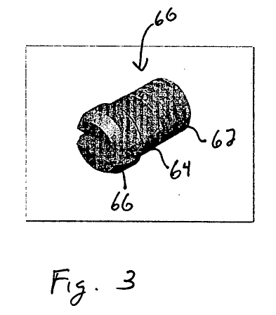

To install the latch set 10 using the mounting plate 50 of the present invention, latch 32 is inserted in a bore (not shown), which is transverse to door bore 17, in door 16 and is attached to door 16 with screws (not shown). Latch operator 14 is manually positioned or held on one side of door 16 with spindle 24 extending into a corresponding aperture in latch 32. Mounting plate 50 is positioned against the opposite side of door 16 with the mounting plate central aperture 52 aligned with the bore 17 in door 16. Screws 28 are the used to attach the mounting plate 50 to latch operator 14. The screws 28 are tightened to hold the connected mounting bracket 50 and latch operator 14 in place on door 16. At this point, the connected components are “hands free”, that is, it is no longer necessary to manually hold the latch operator 14 against the door. This arrangement of the mounting plate 50 and the latch operator 14 is shown in FIG. 4.

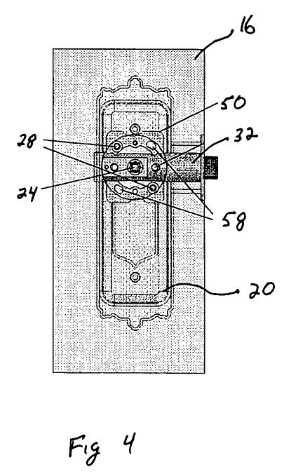

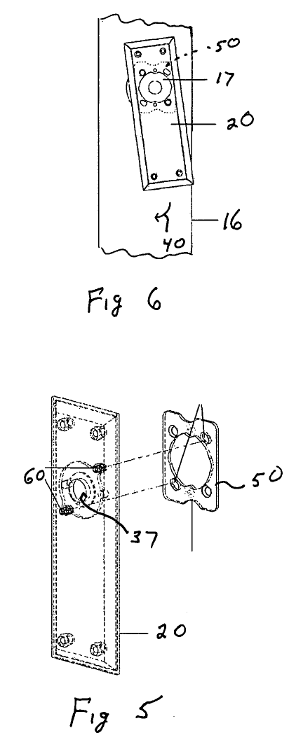

Next, referring to FIGS. 5 and 6, latch operator 12 is aligned in a slightly rotated position on the other side of door 16 with mounting plate 50, as shown in FIG. 6. In this rotated position, the heads 66 of retention bosses 60 are aligned with the larger section of retention apertures 58. Latch operator 12 is moved towards the door 16 so that the retention boss heads 66 extend through mounting plate retention apertures 58. Latch operator 14 is then rotated counter clockwise, as indicated by arrow 40, to a normal installed position. As the latch operator 12 is rotated, retention boss tapered sections 64 press against the edges of the retention aperture 58, forcing latch operator 12 to move towards the mounting plate 50 and tighten against door 16.

Once both latch operators 12, 14 are attached to mounting plate 50, the latch operators are aligned so that the long edge of the long plates 20 are parallel to the edge of the door 16. Finally, both latch operators are further secured to door 16 with a plurality of screws 34.

The installation of a rose 21, see FIG. 1A, is similar to the installation of a long plate 20. In a preferred embodiment, threaded holes 54 on mounting plate 50 are used along with screws 28 to attach the mounting plate 50 to the latch operator 14. After the rose latch operator 14 is attached to the door 16, the installation of long plate latch operator 12 proceeds as described above.

When the long plates are used with levers, rather than knobs, using the mounting plate 50 with the retention bosses 60 adds strength to resist rotation of the installed long plate due to the additional force during use caused by the lever.

Having described the invention, what is claimed is:

1. A mounting plate comprising:
a plate having a central aperture therein;
a plurality of sets of attachment apertures in the plate, each set comprising two attachment apertures, the two attachment apertures in each set being diametrically opposed to one another about the central aperture; and
two retention apertures in the plate, the two retention apertures being diametrically opposed to one another about the central aperture.

2. The mounting plate according to claim 1, wherein one set of attachment apertures is circumferentially offset from an adjacent set of attachment apertures.

3. The mounting plate according to claim 2, wherein the retention apertures are circumferentially offset from the sets of attachment apertures.

4. The mounting plate according to claim 1, wherein at least one set of attachment apertures is unthreaded.

5. The mounting plate according to claim 4, wherein at least one set of attachment apertures is threaded.

6. A latch set comprising:
a mounting plate according to claim 1;
a first latch operator having two female threaded bosses;
a second latch operator having two retention bosses; and
two screws, the screws extending through the attachment apertures of one set of attachment apertures and threadedly engaging the first latch operator female threaded bosses,
each retention boss extending through a mounting plate retention aperture and retainingly engaging the mounting plate with the second latch operator.

7. The latch set according to claim 6, wherein each retention boss comprises a threaded screw attached to the second latch operator.

8. The latch set according to claim 6, wherein each retention boss comprises a shaft portion having a first diameter and a head portion having a second diameter, the second diameter being larger than the first diameter,
each retention aperture comprising a first section having a size that permits the retention boss head to pass therethrough and a second section having a size that prevents the retention boss head from passing therethrough.

9. The latch set according to claim 8, wherein each retention boss further comprises a tightening portion between the head portion and the shaft portion, the tightening portion being in contact with retention aperture edges.

10. The latch set according to claim 9, wherein the diameter of the tightening portion adjacent the head portion is smaller than the diameter of the head portion, the diameter of the tightening portion adjacent the shaft portion is at least as large as the diameter of the shaft portion, the diameter of the tightening portion increasing from the diameter adjacent the shaft portion to the diameter adjacent the head portion.

11. The latch set according to claim 6, wherein the first latch operator includes one of a long plate and a rose; and the second latch operator includes one of a long plate and a rose.

12. The latch set according to claim 6, wherein the first latch operator includes one of a long plate and a rose, and the second latch operator includes the other of a long plate and a rose.

13. The latch set according to claim 6, wherein each latch operator includes a long plate, each long plate having an aperture therein, two interiorly threaded bosses diametrically positioned about the aperture, the retention bosses threadedly engaging the second latch operator long plate threaded bosses.

14. The latch set according to claim 13, wherein the first latch operator threaded bosses comprise extended screw bosses threadedly engaging the first latch operator threaded bosses, the screws threadedly engaging the extended screw bosses.

15. A latch set comprising:
two latch operators; and
a mounting plate attached to the latch operators, the mounting plate having a central aperture, two sets of attachment apertures, the two attachment apertures in a set being diametrically opposed to one another about the central aperture; and two retention apertures diametrically opposed to one another about the central aperture, the mounting plate being attached to one latch operator using one set of attachment apertures, the mounting plate being attached to the other latch operator using the retention apertures.

16. The latch set according to claim 15, wherein the latch operators comprise two threaded bosses; and further comprising:
retention bosses threadedly engaging the threaded bosses of one latch operator, the retention bosses also retainingly engaging the mounting plate retention apertures.

17. The latch set according to claim 16, further comprising:
two screws extending through one set of attachment apertures and threadedly engaging the threaded bosses of the other latch operator.

18. The latch set according to claim 16, wherein each retention boss comprises a shaft portion having a first diameter and a head portion having a second diameter, the second diameter being greater than the first diameter,
each retention aperture comprising a first section having a size that permits the retention boss head to pass therethrough and a second section having a size that prevents the retention boss head from passing therethrough.

19. The latch set according to claim 18, wherein each retention boss further comprises a tightening portion between the head portion and the shaft portion, the tightening portion being in contact with retention aperture edges, the diameter of the tightening portion adjacent the head portion being smaller than the diameter of the head portion, the diameter of the tightening portion adjacent the shaft portion being at least as large as the diameter of the shaft portion, the diameter of the tightening portion increasing from the diameter adjacent the shaft portion to the diameter adjacent the head portion.

20. The latch set according to claim 15, wherein one latch operator includes one of a long plate and a rose; and the other latch operator includes one of a long plate and a rose.

21. The latch set according to claim 15, wherein one latch operator includes one of a long plate and a rose; and the other latch operator includes the other of a long plate and a rose.

22. A method of installing a latch set on a door comprising the steps of:
providing a first latch operator, the first latch operator having two female threaded bosses;
providing a second latch operator, the second latch operator having two retention bosses extending therefrom;
providing a mounting plate, the mounting plate having: a central aperture; two attachment apertures diametrically opposed to one another about the central aperture; and two retention apertures diametrically opposed to one another about the central aperture;
positioning the first latch operator on a first side of the door, the two female threaded bosses extending into a bore in the door;
manually holding the first latch operator on the first side of the door;
positioning the mounting plate on a second side of the door, the mounting plate central aperture being aligned with the door bore;
attaching the mounting plate to the first latch operator with a plurality of screws;
releasing the manual holding of the first latch operator;
positioning the second latch operator on the second side of the door, and aligning the second latch operator in a position rotated from a normal installed position of the second latch operator;
aligning the retention bosses with the larger end of the mounting plate retention apertures;
placing the retention boss heads through the larger end of the mounting plate retention apertures; and
attaching the second latch operator to the mounting plate by rotating the second latch operator to the normal installed position.

23. The method according to claim 22, wherein the step of providing a first latch operator comprises providing a first latch operator having a long plate, and the step of providing a second latch operator comprises providing a second latch operator having one of a long plate or a rose.

24. The method according to claim 22, further comprising:
after the step of releasing the manual holding the first latch operator, attaching the first latch operator to the first side of the door with a plurality of threaded fasteners.

25. The method according to claim 22, further comprising:
after the step of attaching the second latch operator to the mounting plate, attaching the second latch operator to the second side of the door with a plurality of threaded fasteners.
